(19) United States
(12) Patent Application Publication
(10) Pub. No.: US 2020/0237168 A1
(43) Pub. Date: Jul. 30, 2020

(54) DRONE CLEANING APPARATUS AND METHOD FOR ELEVATED STRUCTURES AND CEILINGS

(71) Applicant: Nu Metrix LLC, Minneapolis, MN (US)

(72) Inventor: Mary Susan Perpich, Minneapolis, MN (US)

(21) Appl. No.: 16/773,201

(22) Filed: Jan. 27, 2020

Related U.S. Application Data
(60) Provisional application No. 62/797,995, filed on Jan. 29, 2019.

(51) Int. Cl. A47L 9/00; A47L 5/22; A47L 7/00; A47L 9/28; A47L 9/06; B08B 5/04; B64C 39/02

(52) U.S. Cl. CPC A47L 9/009; A47L 5/22; A47L 7/0085; A47L 9/281; A47L 9/2852; A47L 9/2894; B08B 3/04; B08B 5/04; B64C 39/024; A47L 9/2878; A47L 2201/04; A47L 2201/06; A47L 9/0606

(57) ABSTRACT

A cleaning method and apparatus for elevated structures and ceilings, such as open girder truss systems, utilizes a multi-rotor blade helicopter/drone together with a contaminant entrainment system. More specifically, the drone includes a contaminant entrainment system including a vacuum and filter for entraining the contaminants dislodged from the elevated structures, a cleaning head to engage the surface to be cleaned, a system to guide the drone's flight path proximate the elevated structures to be cleaned, and optionally a power tether to reduce battery weight and increase the flight time of the drone.

### CROSS-REFERENCE TO RELATED APPLICATIONS

This application claims the benefit of U.S. Provisional Patent Application No. 62/797,995, filed Jan. 29, 2019, entitled, “DRONE CLEANING APPARATUS AND METHOD FOR ELEVATED STRUCTURES AND CEILINGS.” The disclosure of this priority application is hereby incorporated by reference in its entirety into the present application.

### FIELD OF THE INVENTION

The present invention relates generally to a cleaning method and apparatus for elevated structures and ceilings. More specifically, a multi-rotor blade helicopter (hereinafter “drone”) is utilized together with a contaminant entrainment system to clean elevated structures such as an open girder truss system as commonly found in, among other spaces, commercial factories and warehouses. Still more specifically, the drone includes a vacuum and filter system for entraining dust, dirt, grime, soot, filings, etc. (hereinafter “contaminants”) dislodged from the elevated structures and a system to guide the drone's flight path through the elevated structures to be cleaned.

### BACKGROUND

There are numerous large commercial, industrial and warehouse buildings in the world. Many of these buildings have elevated surfaces. Some use a girder truss system that eliminates the need for load bearing walls below and results in an open floor plan. Other facilities that use this type of construction include school gymnasiums, arenas, big box stores, grocery stores, and shopping malls, among others. In many cases the roof of these facilities are flat and in other cases the roof is constructed with a pitch. However, in either case, the construction typically includes a roof panel and insulation set on top of the girder truss system and clipped/banded to the system. In some applications, one of the members of the girders is referred to as a bar joist. Because the insulation is on top of the girder truss system, there is often no need to place a covering at the bottom of the system (e.g., create a ceiling at the bottom of the girder truss system). The result of having an open, exposed girder truss system means that eventually contaminants will collect on the various elements of the girder truss system—and especially on the upward-facing horizontal surfaces.

Currently, to the extent that the elevated surfaces are actually cleaned, the process generally involves use of an articulated lift or scissor lift device. During the process, an individual guides the lift device to the area to be cleaned, physically climbs onto a work platform, raises the device to the girder level and then cleans the limited area within reach. Generally, individual must lower the lift device, move it to a new location, and begin the process again. Therefore, the process is tedious, with significant time and expense being involved.

Although some lift devices are capable of being moved while in a raised position, there may be safety concerns in doing so. For example, there may be obstacles on the floor of the facility, the height of the platform may make the lift device less stable, and/or the work platform (or occupant) may be at risk of collision with a girder or other member of the girder truss system. Because of the nature of the difficulties, there is a significant time and expense associated with such a cleaning operation.

Further, the current method described above does not take into consideration the entrainment of the contaminants that are dislodged in the cleaning process. Especially in facilities such as grocery stores and manufacturing plants, cleaning of the elevated system may require more care to minimize the dust from becoming airborne.

Therefore, there arises a need for a method and apparatus to clean the elevated system efficiently and reduce the reliance of an individual cleaning small, discrete portions of the system at a time. Further, there arises a method and apparatus for cleaning elevated systems while entraining the material removed from the cleaned surface to minimize the dust from becoming airborne.

### SUMMARY

The present invention relates to a cleaning method and apparatus for elevated structures. In a preferred embodiment, a drone is utilized together with a dust entrainment system to clean elevated structures such as open girder truss systems commonly found in commercial factories, warehouses, school gymnasiums, arenas, big box stores, and grocery stores, among others (referred to collectively herein as “facilities”). The drone preferably utilizes variously shaped cleaning heads to clean the differing geometry surfaces, where the cleaning heads may include fixed or rotating bristles. The bristles may be soft, stiff or metal. The cleaning heads are connected via a suitable conduit to the contaminant entrainment system (e.g., a vacuum source and a filter) for entraining the dust and other particles, etc. removed from the elevated structure. Optionally, water, a solvent or other fluidic cleaner may be delivered to the surface to be cleaned.

A camera is preferably located on the drone so that a user can ascertain that the various surfaces are being properly cleaned. Further, the camera may aid in navigation of the drone during cleaning and/or during a manual flight operation while programming (e.g., for example using either human operated or autonomous operation). Proximity sensors may also be located on the drone to aid in navigation, and to avoid collisions with the structures in the truss system.

Optional power tethering and/or command tethering of the drone may be used for additional power (e.g., to increase the flight time) to the drone. Further, tethering may be utilized to improve flight time by reducing the battery weight—thereby allowing for a more robust cleaning system with a smaller drone.

Therefore, according to a first aspect of the invention, there is provided a system for cleaning elevated structures comprising: a multi-rotor drone; a bracket having a first end and a second end, the bracket operatively coupled to the drone at the first end; a cleaning head coupled to the bracket at the second end; a contaminant entrainment system carried by the drone; and a conduit connecting the cleaning head to the contaminant entrainment system, wherein when the drone is flown proximate to the elevated structure to be cleaned, the cleaning head picks up contaminants which are transferred to the contaminant entrainment system through the conduit.

According to a second aspect of the invention, there is provided a method of cleaning elevated structures comprising: analyzing the geometry and profiles of the structures to be cleaned and the types of contaminants on the structure; selecting a cleaning head with an appropriate shape and size for the geometry and profiles and for the type of contaminants, and mounting the selected cleaning head on a bracket attached to a drone; establishing a flight path for the drone to fly, wherein the flight path is proximate the structure and places the cleaning head effectively near the structure to be cleaned; moving the cleaning head over the structure to be cleaned by operating the drone along the flight path; and entraining the contaminants removed from the structure.

While the invention will be described with respect to preferred embodiment configurations, methods and specifications, it will be understood that the invention is not to be construed as limited in any manner by either such configuration, methods and/or specifications described herein. Further, while various brush geometries, vacuum producing systems, cleaning systems and contaminant entrainment systems are disclosed herein, the principles of this invention extend to: i) a method of cleaning elevated structures and ceilings; and ii) a drone apparatus arranged and configured to clean elevated structures and ceilings. These and other variations of the invention will become apparent to those skilled in the art upon a more detailed description of the inventions.

The advantages and features which characterize the inventions are pointed out with particularity in the claims annexed hereto and forming a part hereof. For a better understanding of the inventions, however, reference should be had to the drawings which form a part hereof and to the accompanying descriptive matter, in which there is illustrated and described preferred embodiments of the inventions.

### BRIEF DESCRIPTION OF THE DRAWINGS

Referring to the drawings, wherein like numerals represent like parts throughout the several views:

FIG. 1 shows a schematic illustration of the functional elements of a cleaning drone in accordance with the principles of the present invention.

FIG. 2a illustrates a first typical girder truss system.

FIG. 2b illustrates a second typical girder truss system.

FIG. 2c illustrates a third typical girder truss system.

FIG. 3 illustrates a representative cleaning head shown in position relative to a upward facing surface of a girder.

FIG. 4 illustrates a representative bracket used to support the cleaning head.

FIG. 5 illustrates steps that used in connection with cleaning elevated structures using a drone.

### DETAILED DESCRIPTION

As noted above, the present invention relates to a cleaning method and apparatus for elevated structures and ceilings. In a preferred embodiment, as part of its payload, a drone carries a containment entrainment system. The entrainment system includes a cleaning head (for example, a brush with bristles) a conduit connected to the cleaning head at a first end, an entrainment source connected to the conduit at the second end, and a filter system attached to an outlet of the entrainment source. In use, the drone is flown proximate the surface to be cleaned in such a manner as to engage the brush with the surface. Movement of the drone together with the vacuum source being enabled cleans the surface. As the drone if moved along the various horizontal, vertical and angled surfaces, the elevated structure is thereby cleaned.

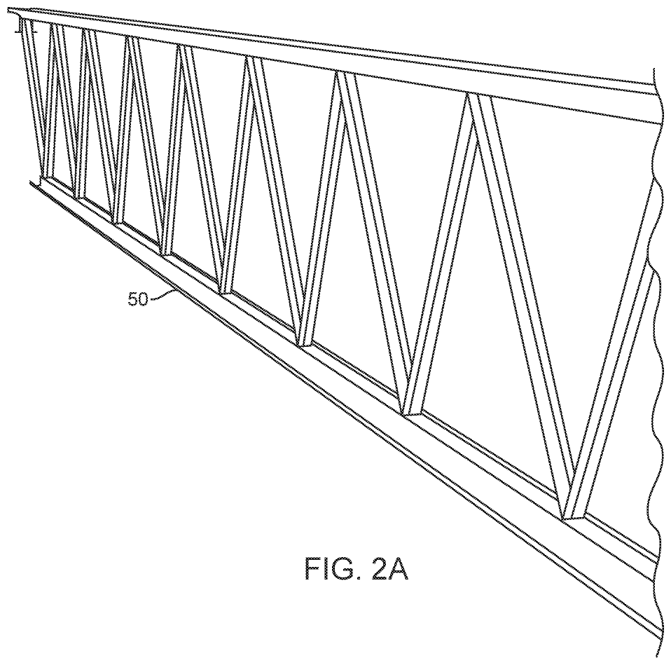

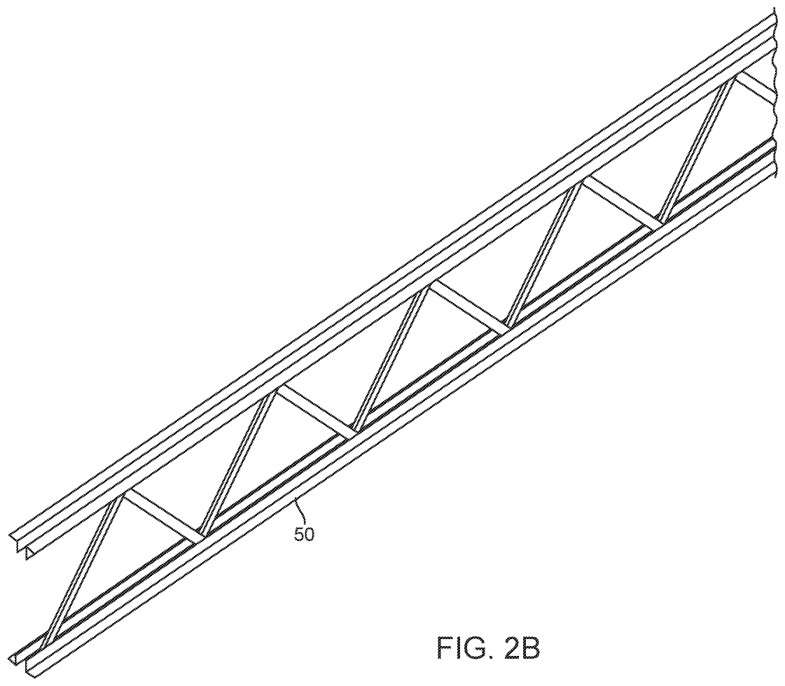

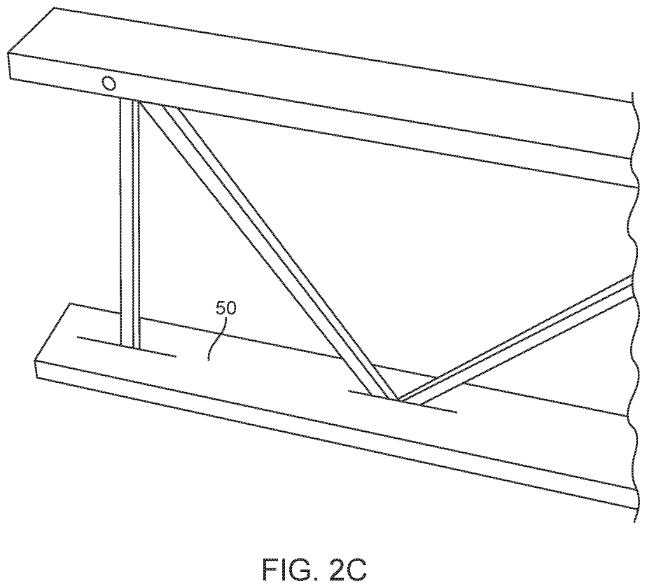

FIGS. 2a, 2b, and 2c illustrate example girder truss structures which may be used in buildings with open ceiling construction. Because the structures include various profiles and horizontal surfaces, it will be appreciated that differently sized and shaped cleaning heads may be useful and/or required.

Embodiments, examples and preferred specifications of the drone cleaning method and apparatus for elevated structures and ceilings are next described.

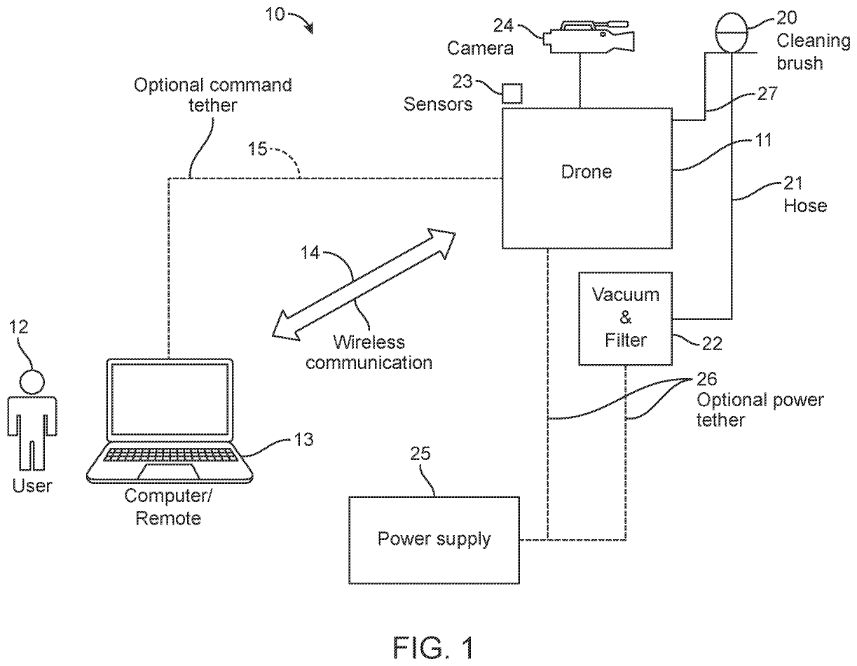

First referring to FIG. 1, there is provided a drone cleaning system referred to generally at 10. The drone 11 is capable of being controlled manually by a user 12. However, the drone 11 may be controlled and programmed by a computer program processed by computer 13 (or other application being run on a tablet or smart device). In addition, the drone 11 may be operated manually with the remote control typically provided with the drone 11. The resulting manual or automated commands are transmitted to the drone 11 wirelessly 14 or via optional command tether 15.

In the preferred embodiment, the drone 11 is preferably selected to have specifications to carry the necessary payload and achieve a flight time that is suitable for the cleaning application. In an embodiment constructed according to the principles of the invention, a drone manufactured by DJI Technology Co. Ltd. Of Shenzhen, Guangdong, China, under the model number “Matrice 600” may be utilized. This drone is capable of carrying a 6 kg payload and flight time of sixteen (16) minutes. It will be appreciated by those skilled in the art that a larger drone may be utilized based on the weight of the payload—including an additional battery source if desired. For example, DJI manufactures a drone model number AgraMG-1 that is capable of carrying a 10 kg payload and a flight time of twenty-four (24) minutes.

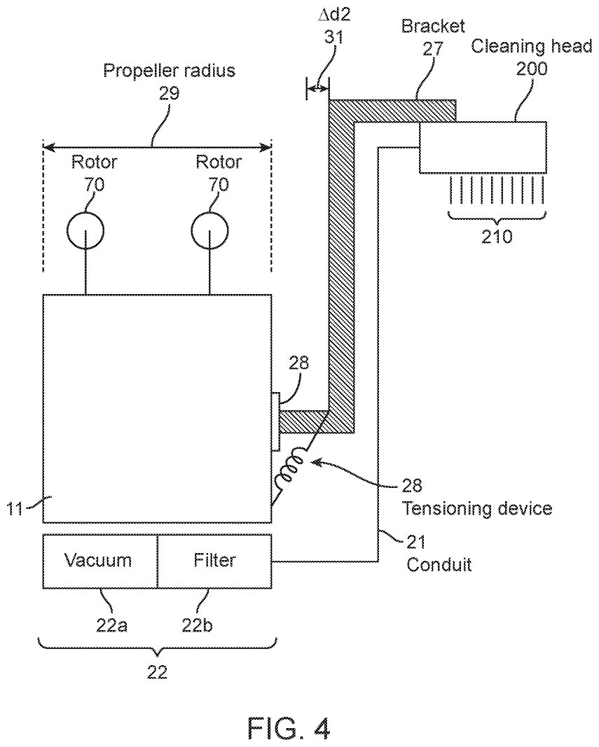

While the drone is shown schematically in FIGS. 1 and 4, and only two propellers are shown for clarity in FIG. 4, it will be appreciated that many differing styles of drones may be utilized. Also, drones having differing number of propellers and positioning may be used. Further, the propellers may be located beneath the drone in some embodiments.

Elements of the system 10 carried aloft by the drone 11 include the contaminant entrainment system (e.g., vacuum and filter) 22, connecting conduit (e.g., hose) 21, cleaning head (e.g., brush) 20, bracket 27, camera 24 and sensors 23. Each of these elements will be next described.

The contaminant entrainment system 22, may be comprised of a vacuum source and a filter. The vacuum source and filter may be selected in accordance with the level of entrainment required by the application. For example in a food processing or other clean or sterile setting, the level of entrainment and filtering is significantly heightened. Alternatively, in other settings, dust and other contaminant entrainment may be relaxed, and in some settings, the dust entrainment system 22 may not be required at all.

In an example embodiment the dust entrainment system 22 may include a vacuum source 22a and filter 22b. One vacuum embodiment that might be used is a vacuum manufactured under the Oreck Commercial brand headquartered in Nashville, Tenn. under the model number BB900DGR XL Pro 5 Super Compact Canister Vacuum. This particular vacuum while being lightweight and having an attached conduit hose, is an A.C. vacuum. Accordingly, in applications where a power tether is not desired or possible, a battery powered or cordless vacuum may be used.

The filter 22b may be the filter included with the above described Oreck vacuum. However, a number of applications may require additional filtering (i.e., than that provided by the standard Oreck filter). In such situations an additional filter cartridge with the appropriate HEPA rating may be included with a suitable filter canister (not shown).

Conduit 21 may be any fluid communication means for connecting the contaminant entrainment system 22 to the cleaning head 20. Preferably, the conduit 21 is arranged and configured to provide some freedom of motion. For example, a slinky type hose with a coiled metal structure and flexible outer plastic material may be used. However, other conduits manufactured of plastics and other materials may be used.

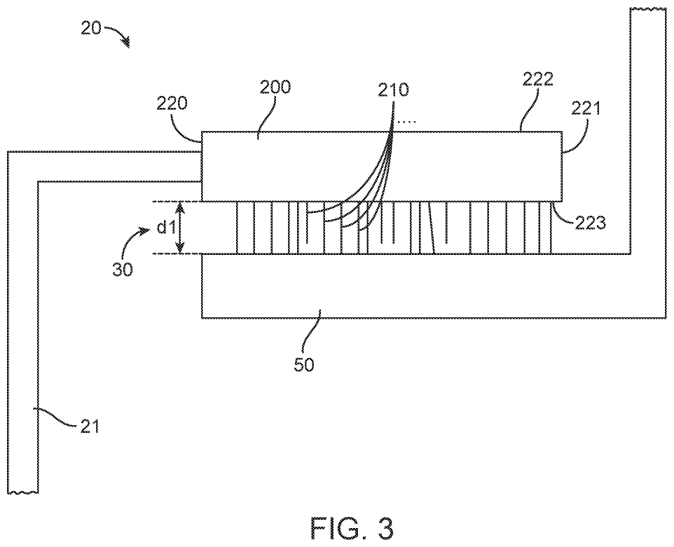

The cleaning head 200 may be constructed as a brush. One representative configuration is shown in FIGS. 3 and 4. In this configuration, the conduit 21 is attached at a first end 220 of the brush 200 and the second end 221 is closed. The top side 222 of the brush is connected to bracket 27 (described below). The bottom side 223 of the brush includes a plurality of bristles 210 and at least one opening for the vacuum source to pull the contaminants dislodged during the cleaning process into the conduit 21 and subsequently into the filter 22b. The bristles 210 engage with surface 50 during cleaning to assist in the removal of contaminants.

The brush may take other forms and include soft or stiff bristles, metal bristles, and rotating bristles without departing from the principles of the present invention. In addition, the structure, materials and structure of the cleaning head 20 may be selected based on the application and the requirements of the elevated surfaces to be cleaned.

Referring to FIG. 4, bracket 27 is used to connect the cleaning head 200 to the drone 11. Due to the various angles and shapes of the surfaces to be cleaned, the bracket 27 may be adjustable and/or may be selected from a plurality of variously configured brackets. Accordingly, mounting plate 28 may be included on the drone 11 to assist with the removal, replacement and selection of the bracket 27 from the drone 11. The mounting plate 28 and bracket 27 may utilize a variety of quick connection devices and schemes to assist in this function.

It will be appreciated that the bracket 27 and ultimate location of the cleaning head 200 must avoid the propellers or rotors 70 of the drone 11. In an embodiment, the bracket 27 is located outside of the propeller 70 radius identified in FIG. 4 as Propeller Radius 29. By locating the bracket 27 outside of this radius 29 and above the rotors 70, the bracket 27 may position the cleaning head 200 above the horizontal surface of the elevated structure 50 (best seen in FIG. 3). The bracket 27 may also be flexible in a manner to pivot or flex relative to the application of force from the interaction of the cleaning head 200 and bristles 210 with the elevated structure 50. For example, the drone 11 may not fly in a single horizontal line, and so the distance d1 (best seen in FIG. 3 with the designation 30) between the cleaning head 200 and surface 50 may vary. Based on the type of bristle 210 or other structure, this may cause bracket 27 to move in a manner indicated by d2 (best seen in FIG. 4 with the designation 31). To compensate for this movement and to maintain necessary contact between the bristles 210 and surface 50, the biasing member 28 may be utilized to counter the movement and force. Biasing member may be a tensioning device, elastic member or spring, among others.

Returning now to FIG. 1, as described above camera 24 may be provided for the user 12 to view the location and operation of the drone 11. Such cameras are often employed as standard equipment on drones for this use. Sensors 23 are preferably located on the drone 11 to assist with various functions—e.g., such as positioning of the drone 11 relative to the elevated structures and surfaces. In an embodiment, at least one sensor 23 may be used to assist with the positioning of the drone 11 during the cleaning operation. The sensor 23 may provide information on the distance between the drone 11 and the surface 50, such that a desired or necessary distance is maintained for cleaning. The data may be used reviewed manually by the user 12 or be an automated input signal to programmed or automated flight. It will be appreciated that other sensors may also be utilized. For example, sensor 23 may provide gps coordinates, collision detection and/or geo-fencing functionality.

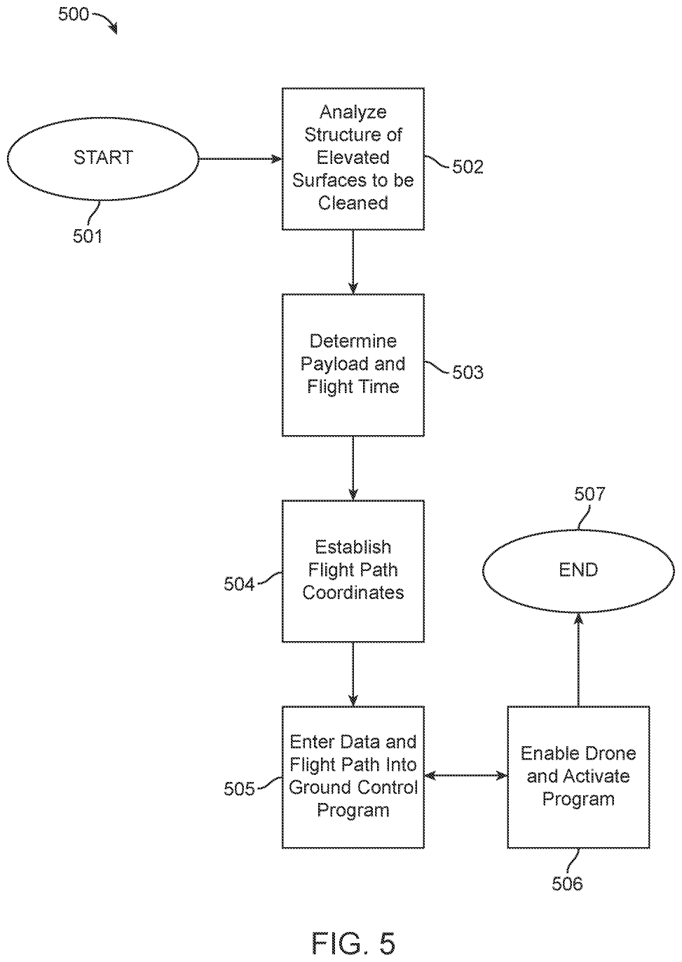

FIG. 5 illustrates the method used by system 10 to clean elevated surfaces and structures. The method begins at 501 and moves to block 502 where the elevated surfaces and structures are analyzed. Among other parameters that may be determined at this step, the user 12 may determine the necessary or desirable bracket 27, cleaning head 20, filter 22b, and/or sensor 23(and/or distances). In addition, the type of contaminants and the type of facility may be taken into account, as well as the profile of the surface 50 and the linear feet of the surfaces to be cleaned.

At block 503, the payload items and amount of flight time estimated to be necessary for the cleaning process is determined. Such determination may take into account the parameters set forth at block 502, the amount of contaminants that may be carried by the contaminant entrainment system 22, and the capabilities of the drone 11 (e.g., battery/power requirements and payload).

At block 504, the flight path coordinates are established. The coordinates may be determined by recording point-to-point positions manually, by using GPS coordinates, by flying the drone through a representative flight path, by reading a CAD blueprint and/or by using pre-stored coordinates (e.g., having utilized the drone 11 to clean the structure previously), among others.

At block 505 the data is entered into a flight path program. Such programs are commercially available to provide an element of auto-pilot operation for drones.

At block 506, the drone 11 is enabled, the contaminant entrainment system 22 is enabled, and the cleaning process is performed. While finally at block 507 the cleaning process is completed.

In an alternative embodiment, the rotors 70 may be located at the sides of the drone 10. Further still, the rotors 70 may be arranged and configured to be located beneath the drone 10. Benefits may result from either of these arrangements. For example, the mounting plate 28 and bracket 27 may be located closer to the longitudinal y-axis of the drone 10, the mounting plate 28 and bracket may be otherwise more preferentially mounted, the bracket 27 may be designed to be shorter in the x-axis direction, and/or the drone 10 may be able to fly on a flight path closer to the structure to be cleaned.

In another alternative embodiment, the drone 10 and bracket 27 may be arranged and configured to clean elevated windows. In this case, and in those cases where the contaminants warrant, a solvent or other fluidic cleaner may be delivered to the surface to be cleaned.

It should be understood that even though numerous characteristics and advantages of the present invention have been set forth in the foregoing description, together with details of the structure and function of the invention, the disclosure is illustrative only and changes may be made in detail, especially in matters of the supporting hardware, components and devices, and to the full extent indicated by the broad general meaning of the terms in which the appended claims are expressed.

What is claimed is:

1. A system for cleaning elevated structures comprising:
a) a multi-rotor drone;
b) a bracket having a first end and a second end, the bracket operatively coupled to the drone at the first end;
c) a cleaning head coupled to the bracket at the second end;
d) a contaminant entrainment system carried by the drone; and
e) a conduit connecting the cleaning head to the contaminant entrainment system, wherein when the drone is flown proximate to the elevated structure to be cleaned, the cleaning head picks up contaminants which are transferred to the contaminant entrainment system through the conduit.

2. The system of claim 1, wherein the drone rotors are located above the drone while in flight, the second end of the bracket extends above the rotors, and the cleaning head is oriented in a direction away from the rotors, whereby the drone may be flown beneath the elevated structure to be cleaned.

3. The system of claim 1, wherein:
a) the cleaning head includes a brush with bristles; and
b) the contaminant entrainment system includes a vacuum source and a filter.

4. The system of claim 1, further comprising a module executed by at least one processor to direct the drone to travel along a specified route proximate the elevated structure to be cleaned and at an elevation that maintains a predetermined distance between the cleaning head and the elevated structure.

5. The system of claim 4, wherein the predetermined distance is a range.

6. The system of claim 5, further comprising at least one proximity sensor mounted on the drone and operatively connected to the processor to generate signals indicative of the distance between the drone and the elevated structure.

7. The system of claim 6, further comprising a biasing member attached to the drone at a first end and the bracket at a second end, wherein the bracket is flexible in an x-axis direction toward the drone rotors, and wherein the biasing member is arranged and configured to urge the bracket away from the rotors, whereby the cleaning head engages the elevated structure as the drone moves along the flight path and the predetermined distance between the cleaning head and the elevated structure is maintained in the event that the flight path varies from a constant vertical height.

8. The system of claim 1, further comprising:
a) a power source;
b) a tether arranged and configured to extend between the power source and the drone and capable of carrying power to the drone from the power source.

9. The system of claim 3, wherein the filter is a high-efficiency particulate arrestance (HEPA) filter.

10. A method of cleaning elevated structures comprising:
a) analyzing the geometry and profiles of the structures to be cleaned and the types of contaminants on the structure;
b) selecting a cleaning head with an appropriate shape and size for the geometry and profiles and for the type of contaminants, and mounting the selected cleaning head on a bracket attached to a drone;
c) establishing a flight path for the drone to fly, wherein the flight path is proximate the structure and places the cleaning head effectively near the structure to be cleaned;
d) moving the cleaning head over the structure to be cleaned by operating the drone along the flight path; and
e) entraining the contaminants removed from the structure.
